(19) United States
(12) Patent Application Publication
(10) Pub. No.: US 2017/0354956 A1
(43) Pub. Date: Dec. 14, 2017

(54) HIGH-TEMPERATURE SYNTHESIS OF HEXAALUMINATES BY FLAME SPRAYING PYROLYSIS

(71) Applicant: BASF SE, Ludwigshafen (DE)

(72) Inventors: Rene KOENIG, Neustadt (DE); Wieland KOBAN, Mannheim (DE); Andrian MILANOV, Mannheim (DE); Ekkehard SCHWAB, Neustadt (DE); Stephan A SCHUNK, Heidelberg-Rohrbach (DE); Carlos LIZANDARA, Heidelberg (DE); Guido WASSERSCHAFF, Neckargemuend (DE)

(73) Assignee: BASF SE, Ludwigshafen (DE)

(21) Appl. No.: 15/521,018

(22) PCT Filed: Oct. 23, 2015
(86) PCT No.: PCT/EP2015/074583

§ 371 Date: Apr. 21, 2017

(30) Foreign Application Priority Data
Oct. 24, 2014 (EP) 14190316.1

(51) Int. Cl. B01J 23/83; B01J 37/08; B01J 37/04; C01G 51/00; C01B 3/02

(52) U.S. Cl. CPC B01J 23/83; C01G 51/70; C01B 3/02; B01J 37/04; B01J 37/088; B01J 37/086

(57) ABSTRACT

The invention relates to a process for preparing aluminates of the general formula (I)

A₁BₓAl₁₂₋ₓO_{19-y}
where
A is at least one element from the group consisting of Sr, Ba and La,
B is at least one element from the group consisting of Mn, Fe, Co, Ni, Rh, Cu and Zn,
x=0.05-1.0,
y is a value determined by the oxidation states of the other elements,
which comprises the steps
(i) provision of one or more solutions or suspensions comprising precursor compounds of the elements A and B and also a precursor compound of aluminum in a solvent,
(ii) conversion of the solutions or suspensions or the solutions into an aerosol,
(iii) introduction of the aerosol into a directly or indirectly heated pyrolysis zone,
(iv) carrying out of the pyrolysis and
(v) separation of the resulting particles comprising hexaaluminate of the general formula (I) from the pyrolysis gas.

The invention relates to a process for preparing aluminates comprising at least one element A from the group consisting of Sr, Ba and La and at least one element B from the group consisting of Mn, Fe, Co, Ni, Rh, Cu and Zn, the hexaaluminates themselves and also their use.

The preparation of hexaaluminates by wet-chemical processes is known.

U.S. Pat. No. 4,788,174 describes the preparation of catalysts for catalytic combustion having the formula A_{1-z}C_{z}BₓAl_{12-y}O_{19-α}, where A is selected from among Ba, Ca and Sr, C is selected from among K and Rb, and B is selected from among Mn, Co, Fe, Ni, Cu and Cr, and z=0 to 0.4 and x=0.1 to 4, in which water- or alcohol-soluble compounds of the elements A, B and C and also of aluminum are dissolved in water or alcohol, precipitated as precipitate, the latter is separated off from the solution and is calcined at temperatures of not less than 900° C. Compositions of the formulae BaMnAl₁₁O_{19-α}, BaFeAl₁₁O_{19-α}, BaCoAl₁₁O_{19-α} and BaCuAl₁₁O_{19-α}, inter alia, are specifically disclosed.

A disadvantage of this process is the long calcination times. In the examples, these are at least 5 hours at temperatures of at least 1200° C. after precalcination at temperatures of 300° C. The hexaaluminates obtained have specific surface areas in the range 3-23 m²/g.

U.S. Pat. No. 5,830,822 discloses the wet-chemical preparation of catalysts for catalytic combustion having the formula Al₁₋ₓB_{y}C_{z}Al_{12-y-z}O_{19-δ}, where A is barium, strontium or a rare earth metal, B is an element selected from among Mn, Co and Fe and element C is Mg and/or Zn, x=0 to 0.25, y=0.5 to 3 and z=0.01 to 3. Materials having the compositions BaMn_{0.5}Mg_{0.5}Al₁₁O_{19-δ}, BaMgAl₁₁O_{19-δ}, BaMnAl₁₁O_{19-δ} and SrMnAl₁₁O_{19-δ}, inter alia, are specifically disclosed. In an example, a solution of aluminum nitrate, lanthanum nitrate, manganese nitrate and magnesium nitrate in water is admixed with ammonia, the precipitated precipitate is separated off, washed and calcined in air at from 600° C. to 1200° C. A composition of the formula La_{0.78}Mg_{0.9}Mn_{0.9}Al₁₁O_{19-δ} is obtained.

The long calcination times are likewise disadvantageous here. In the examples, they are 16 hours at a temperature of 1200° C. after precalcination for 4 hours at a temperature of 600° C. The hexaaluminates obtained have specific surface areas of less than 20 m²/g.

US 2003/0176278 A1 discloses the preparation of hexaaluminates of the formula

M1_{X}M2_{Y}M3_{Z}Al_{12-(X+Y+Z)}O₁₈₋₆₀.

where
M1 is selected from among La, Ce, Nd, Sm, Eu, Gd, Er, Yb and Y,
M2 is selected from among Mg, Ca, Sr and Ba, and
M3 is selected from among Mn, Fe, Co, Ni, Cu, Ag, Au, Rh, Ru, Pd, Ir and Pt, from an aluminoxane precursor by metal ion exchange and heating of the aluminoxane precursor to temperatures of from 1000 to 1500° C. The catalytic combustion of hydrocarbons in order to reduce NOₓ emissions is mentioned as application of the hexaaluminate catalyst.

This process comprises two high-temperature calcination steps. The preparation of modified aluminoxane is carried out at temperatures of about 800° C. and a hold time of 1 hour. The preparation of the hexaaluminate is carried out at temperatures of about 1300° C. and a hold time of 3 hours. The hexaaluminate obtained in the examples have specific surface areas in the range of 5 to 10 m²/g.

EP 2 119 671 A1 discloses a process for preparing hexaaluminates which comprises the steps
a) provision of a porous template material,
b) impregnation of the material with an aqueous solution of metal salts,
c) drying of the impregnated material,
d) optionally repetition of steps b) and c),
e) calcination of the dried material in an inert gas atmosphere and
f) isolation of the hexaaluminate by removal of the template material from the calcined material.

In the examples, lanthanum hexaaluminates of the formulae LaAl₁₁O₁₈, LaMnAl₁₁O₁₉ and LaMgAl₁₁O₁₉ are prepared by impregnation of a carbon xerogel with an aqueous solution of lanthanum nitrate, aluminum nitrate, magnesium nitrate and manganese nitrate, drying and calcination at 1300° C. in an inert gas atmosphere and removal of the template material by calcination at 1000° C. in air. The use of the hexaaluminates in the catalytic combustion of lean fuel mixtures in order to minimize NOₓ and CO emissions is also disclosed.

Although the process leads to hexaaluminates having relatively high specific surface areas in the range 50-60 m²/g, this also requires a long calcination time of at least 5 hours at 1300° C. in an inert gas atmosphere and at least 10 hours at temperatures of 1000° C. in humid air. The hexaaluminates obtained have a relatively high proportion of secondary phases.

DE 10 2005 062 926 A1 discloses a process for preparing hexaaluminates for the catalytic combustion of hydrocarbons, in particular methane, which have the formula

A_{1-z}B_{z}CₓAl_{12-y}O_{19-α},

where
A is at least one element selected from among Ca, Sr, Ba and La,
B is K and/or Rb,
C is at least one element from the group consisting of Mn, Co, Fe and Cr,
z=0-0.4, and
x=0.1-4, wherein
an aqueous solution of an alkaline earth metal nitrate is produced, the aqueous solution is acidified to a pH of less than 2, an aluminum salt is added to the acidified aqueous solution, the clear aluminum-comprising solution obtained is introduced into an aqueous solution of (NH₄)₂CO₃, the precipitated hexaaluminate is separated off and calcined at a temperature of more than 1050° C. and is subsequently milled to a particle size of less than 3 μm. As a specific use of the hexaaluminate catalyst, mention is made of the steam reforming of methane by means of steam to produce hydrogen for fuel cells.

The hexaaluminates prepared by this process achieve specific surface areas of less than 20 m²/g. The long calcination time of 16 hours at temperatures of above 1150° C. is likewise disadvantageous.

WO 2013/135710 discloses mixed oxides of various structures as catalysts for the “reverse water gas shift reaction” (RWGS reaction), including hexaaluminates. Nothing is said about the preparation and properties of the catalysts.

WO2013/118078 and US2013116116 disclose the use of various mixed metal oxides as catalysts for the reforming of hydrocarbons, preferably of methane, and CO₂. Among other things, no mention is made of phase-pure hexaaluminates having specific surface areas of less than 20 m²/g which are obtained by calcination at 1100° C. for a number of hours.

It is an object of the invention to provide a simple and inexpensive process for preparing aluminates, preferably hexaaluminates having a high specific surface area. The aluminates should be thermally and chemically stable in respect of their sintering properties and in respect of their carbonization behavior in a gas atmosphere comprising hydrocarbons, for example methane, and at relatively high temperatures (500-1000° C.). It is in particular an object of the invention to provide a simple process for preparing aluminates, preferably hexaaluminates, which are suitable as reforming catalysts for producing synthesis gas from methane and carbon dioxide and as catalysts for the RWGS reaction.

The object is achieved by a process for preparing aluminates of the general formula (I)

A₁BₓAl₁₂₋ₓO_{19-y}

where
A is at least one element from the group consisting of Sr, Ba and La,
B is at least one element from the group consisting of Mn, Fe, Co, Ni, Rh, Cu and Zn,
x=0.05-1.0,
y is a value determined by the oxidation states of the other elements,
which comprises the steps
(i) provision of one or more solutions or suspensions comprising precursor compounds of the elements A and B and also a precursor compound of aluminum in a solvent,
(ii) conversion of the solutions or suspensions into an aerosol,
(iii) introduction of the aerosol into a directly or indirectly heated pyrolysis zone,
(iv) carrying out of the pyrolysis and
(v) separation of the resulting particles comprising the hexaaluminate of the general formula (I) from the pyrolysis gas.

Aluminates according to the invention may be complex aluminates of the hexaaluminate type (hexaaluminates) or of a structural type similar to gamma alumina.

The precursor compounds of the elements A and B and of aluminum which form the aluminate, preferably hexaaluminate, of the general formula (I) are fed as aerosol into the pyrolysis zone. It is advantageous to feed an aerosol which is obtained by atomization of only one solution comprising all precursor compounds into the pyrolysis zone. In this way, it is ensured in all cases that the composition of the particles produced is homogeneous and constant. In the preparation of the solution to be converted into an aerosol, the individual components are thus preferably selected so that the precursor compounds comprised in the solution are present side by side in homogeneously dissolved form up to atomization of the solution (aerosol formation). As an alternative, it is also possible to use a plurality of different solutions which each comprise one or more of the precursor compounds. The solution or solutions can comprise both polar and nonpolar solvents or solvent mixtures.

The solution or solutions preferably comprise the precursor compounds of the elements A, B and of aluminum in the stoichiometric ratio corresponding to the formula (I).

In the pyrolysis zone, decomposition of the precursor compounds to form the aluminate of the elements A and B occurs. Approximately spherical particles having a varying specific surface area are obtained as result of the pyrolysis.

The temperature in the pyrolysis zone is above the decomposition temperature of the precursor compounds at a temperature sufficient for oxide formation, usually in the range from 500 to 2000° C. The adiabatic flame temperature in the pyrolysis zone can be up to 2500° C. or even 3000° C. The pyrolysis is preferably carried out at a temperature of from 900 to 1500° C., in particular at from 1000 to 1300° C.

The pyrolysis reactor can be heated indirectly from the outside, for example by means of an electric furnace. Owing to the temperature gradients from the outside inward which are required in indirect heating, the furnace has to be significantly hotter than the temperature required for the pyrolysis. Indirect heating requires a thermally stable furnace material and a complicated reactor construction, but the total amount of gas required is lower than in the case of a flame reactor.

In a preferred embodiment, the pyrolysis zone is heated by means of a flame (flame spraying pyrolysis). The pyrolysis zone then comprises an ignition device. For direct heating, it is possible to use conventional fuel gases, but preference is given to using hydrogen, methane or ethylene. The temperature in the pyrolysis zone can be set in a targeted manner via the ratio of amount of fuel gas to total amount of gas. To keep the total amount of gas low and nevertheless achieve a very high temperature, pure oxygen can also be fed instead of air as O₂ source into the pyrolysis zone for combustion of the fuel gas. The total amount of gas also comprises the carrier gas for the aerosol and the vaporized solvent of the aerosol. The aerosol or aerosols fed into the pyrolysis zone are advantageously introduced directly into the flame. While air is usually preferred as carrier gas for the aerosol, it is also possible to use nitrogen, CO₂, O₂ or a fuel gas, i.e., for example, hydrogen, methane, ethylene, propane or butane.

A flame spraying pyrolysis apparatus generally comprises a stock vessel for the liquid to be atomized, feed lines for carrier gas, fuel gas and oxygen-comprising gas, a central aerosol nozzle and a ring-shaped burner arranged around this, an apparatus for gas-solids separation comprising a filter element and an offtake device for the solid and also an output for the offgas. Cooling of the particles is effected by means of a quenching gas, e.g. nitrogen, air or steam.

In an embodiment of the invention, the pyrolysis zone comprises a predrier which predries the aerosol by evaporation of the solvent, for example in a flow tube having a heating apparatus arranged around it, before entry into the pyrolysis reactor. If predrying is omitted, there is a risk that a product having a broader particle size distribution and in particular an excessive proportion of fines will be obtained. The temperature of the predrier depends on the nature of the dissolved precursors and on the concentration thereof. The temperature in the predrier is usually above the boiling point of the solvent up to 250° C.; in the case of water as solvent, the temperature in the predrier is preferably in the range from 120 to 250° C., in particular in the range from 150 to 200° C. The predried aerosol which is fed via a line into the pyrolysis reactor then enters the reactor via an exit nozzle.

To produce a more even temperature profile, the combustion space, which is preferably tubular, can be thermally insulated. The combustion space can also be a simple combustion chamber.

The result of the pyrolysis is a pyrolysis gas which comprises nanoparticles having a varying specific surface area. Depending on the solvents used, the size distribution of the particles obtained can be determined essentially directly by the droplet spectrum of the aerosol fed into the pyrolysis zone, the concentration and the volume flow of the solvent or solvents used.

The pyrolysis gas is preferably cooled to such an extent that sintering together of the particles is ruled out before the particles formed are separated off from the pyrolysis gas. For this reason, the pyrolysis zone preferably comprise a cooling zone which adjoins the combustion space of the pyrolysis reactor. In general, cooling of the pyrolysis gas and the aluminate particles comprised therein to a temperature of about 100-500° C. is necessary, depending on the filter element used. Cooling to about 150-200° C. preferably takes place. After leaving the pyrolysis zone, the pyrolysis gas which comprises the aluminate particles and has been partially cooled enters an apparatus for separating the particles from the pyrolysis gas, which comprises a filter element. For cooling, a quenching gas, for example nitrogen, air or humidified air, is introduced.

In a preferred embodiment of the invention, the element A is lanthanum and the element B is cobalt or nickel.

Examples are compositions of the formula

LaNiₓAl₁₂₋ₓO_{19-y}

where x=0.1 to 1.0.

In a further preferred embodiment, element A is lanthanum and element B is cobalt, with particular preference being given to

LaCoₓAl_{12-z}O_{19-y} where x=0.1 to 1.0,
and a special preference being given to LaCoAl₁₁O_{19-y}.

In a further preferred embodiment of the invention, the element A is strontium or barium and the element B is nickel.

Examples are compositions of the formulae

SrNiₓAl₁₂₋ₓO_{19-y}

BaNiₓAl₁₂₋ₓO_{19-y}

where x=0.1 to 1.0.

In a specific embodiment, iron and nickel are both comprised, for example in

La(Fe,Ni)ₓAl₁₂₋ₓO_{19-y}

where x=0.1 to 1.0, preferably 1, especially in

LaFe_{0.5}Ni_{0.5}Al₁₁O_{19-y}.

In further embodiments of the invention, the element A is lanthanum, strontium or barium and the element B is iron, manganese, zinc or copper.

Examples are compositions of the formulae

LaFeₓAl₁₂₋ₓO_{19-y}

LaMnₓAl₁₂₋ₓO_{19-y}

LaZnₓA₁₂₋ₓO_{19-y}

SrZnₓAl₁₂₋ₓO_{19-y}

BaZnₓAl₁₂₋ₓO_{19-y}

LaCuₓAl₁₂₋ₓO_{19-y}

SrCuₓAl₁₂₋ₓO_{19-y}

BaCuₓAl₁₂₋ₓO_{19-y}

where x=0.1 to 1.0, preferably 1.

In a specific embodiment, both copper and zinc are comprised, for example in

La(Cu,Zn)ₓAl₁₂₋ₓO_{19-y}

Sr(Cu,Zn)ₓAl₁₂₋ₓO_{19-y}

Ba(Cu,Zn)ₓAl₁₂₋ₓO_{19-y}

where x=0.1 to 1.0, preferably 1, especially in

LaCu_{0.5}Zn_{0.5}Al₁₁O_{19-y}

SrCu_{0.5}Zn_{0.5}Al₁₁O_{19-y}

BaCu_{0.5}Zn_{0.5}Al₁₁O_{19-y}.

Suitable precursor compounds of the elements A and B are the acetylacetonates (acac), alkoxides or carboxylates and also mixed acetylacetonate-alkoxides of the elements A and B and also hydrates thereof. Suitable precursor compounds can comprise the elements A and B side by side, for example AB(acac)ₓ or ABAl(acac)ₓ. In a preferred embodiment of the invention, the acetylacetonate of the element A and/or B is used as precursor compound of the element A and/or B. Examples are lanthanum acetylacetonate, cobalt acetylacetonate and nickel acetylacetonate.

In a further embodiment of the invention, carboxylates of the element A and/or B are used as precursor compound of the elements A and/or B. Suitable carboxylates are, for example, the acetates, propionates, oxalates, octanoates, neodecanoates, stearates and 2-ethylhexanoates of the elements A or B. A preferred carboxylate of the elements A or B is the 2-ethylhexanoate, for example lanthanum 2-ethyl hexanoate or cobalt 2-ethyl hexanoate.

Further preferred precursor compounds of the elements A and B are the nitrates thereof.

Further preferred precursor compounds of the elements A and B are oxides and hydroxides thereof. These can also be present in suspension in a suitable solvent.

Suitable precursor compounds of aluminum are alkoxides of aluminum. Examples are the ethoxide, n-propoxide, isopropoxide, n-butoxide and tert-butoxide of aluminum. Preferred precursor compounds of aluminum are aluminum sec-butoxide and aluminum isopropoxide.

Further suitable precursor compounds of aluminum are the acetylacetonate, carboxylates, nitrate, oxide and hydroxide thereof. These can be present as solution or suspension in a suitable solvent.

Both polar and nonpolar solvents or solvent mixtures can be used for producing the solution or solutions required for aerosol formation.

Preferred polar solvents are water, methanol, ethanol, n-propanol, isopropanol, n-butanol, tert-butanol, n-propanone, n-butanone, diethyl ether, tert-butyl methyl ether, tetrahydrofuran, glycols, polyols, C₁-C₈-carboxylic acids, for example, acetic acid, ethyl acetate and mixtures thereof and also nitrogen-comprising polar solvents such as pyrrolidones, purines, pyridines, nitriles or amines, e.g. acetonitrile.

Suitable nonpolar solvents are aliphatic or aromatic hydrocarbons having from 5 to 15 carbon atoms, for example from 6 to 9 carbon atoms, or mixtures thereof, for example petroleum spirits. Preferred nonpolar solvents are toluene, xylene, n-pentane, n-heptane, n-octane, isooctanes, cyclohexane, methyl acetate, ethyl acetate or butyl acetate or mixtures thereof.

Particularly preferred solvents are xylene and petroleum spirits (hydrocarbon mixtures). In particular, lanthanum acetylacetonate, cobalt acetylacetonate, lanthanum 2-ethylhexanoate and aluminum sec-butoxide are dissolved in xylene.

The hexaaluminates of the invention generally comprise at least 80% by weight, preferably at least 90% by weight, of the hexaaluminate phase.

The present invention also provides hexaaluminates of the elements A and B which have the general formula (I) and have a BET surface area of from 60 to 120 m²/g, preferably from 60 to 100 m²/g, particularly preferably from 60 to 85 m²/g. These are obtainable, in particular, by the process of the invention.

The crystallite sizes of the hexaaluminates of the invention are generally in the range from 5 to 50 nm, preferably from 15 to 25 nm. These can be determined from the XRD pattern by using the Scherer equation or from transmission electronmicrographs.

In general, the hexaaluminates of the invention are phase-pure (according to the diffraction pattern) and have no undesirable LaAlO₃ and alpha-Al₂O₃ phases but instead consist of hexaaluminate and optionally a phase comparable to gamma-Al₂O₃.

The bulk density of the powder separated off from the pyrolysis gas is generally from 50 to 200 kg/m³. The pore volume determined by the BJH method of the powder is generally from 0.1 to 0.5 cm³/g, and the pore size determined by the BJH method (desorption) of the powder is generally from 3 to 10 nm.

The present invention also provides for the use of the hexaaluminates of the invention as reforming catalyst for producing synthesis gas from methane and carbon dioxide.

The present invention also provides for the use of the hexaaluminates of the invention as catalyst for the RWGS reaction for producing CO-comprising synthesis gas from a gas mixture comprising carbon dioxide and hydrogen and optionally methane.

In the RWGS reaction, carbon dioxide reacts with hydrogen to form carbon monoxide and water:

CO₂+2H₂→CO+H₂+H₂O

CO₂+3H₂→CO+2H₂+H₂O

Various secondary reactions can occur, specifically:

(1) Steam reforming:

CH₄+H₂O→CO+3H₂

(2) Carbon formation:

CH_{y}→C+2H₂

CₘHₙ→xC+Cₘ₋ₓHₙ₋₂ₓ+xH₂

2CO→C+CO₂

CO+H₂→C+H₂O

(3) Carbon gasification:

C+H₂O→CO+H₂

(4) Methanation:

CO+3H₂→CH₄+H₂O

CO₂+4H₂→CH₄+2H₂O

It has surprisingly been found that, in particular, the use of hexaaluminates which have been prepared by means of flame synthesis has advantages over the use of conventionally prepared hexaaluminates for the “reverse water gas shift reaction” (RWGS reaction), in particular in the presence of methane which can originate from a preceding process stage in which partial conversion occurs.

Thus, the hexaaluminates of the invention which have been prepared by flame spraying pyrolysis give a higher hydrogen conversion in the RWGS reaction compared to hexaaluminates prepared by wet-chemical processes. Furthermore, the hexaaluminates of the invention catalyze the methanation reaction to a significantly smaller extent than do wet-chemically prepared hexaaluminates. Finally, the hexaaluminates of the invention have a significantly lower carbonization tendency than wet-chemically prepared hexaaluminates.

### EXAMPLES

### Chemicals Used

Lanthanum 2-ethylhexanoate 10% strength in hexane (LEH)

Lanthanum acetylacetonate (LAA)

Cobalt acetylacetonate (CoAA)

Aluminum sec-butoxide (AlsB)

Xylene (Xyl)

### Examples 1 to 12

The flame synthesis reactor comprises three sections: a metering unit, a high-temperature zone and a quench. By means of the metering unit, the gaseous fuel ethylene, an N₂/O₂ mixture and the metal-organic precursor compounds dissolved in a suitable solvent are fed via a standard two-fluid nozzle (e.g. from Schlick) into the reactor, a combustion chamber which is lined with refractory material or is water-cooled. The reaction mixture is burnt in the high-temperature zone, giving an oxidic product having nanoparticulate properties. Particle growth is stopped by a subsequent quench, in general using nitrogen. The particles are separated off from the reaction offgas by means of a Baghouse filter.

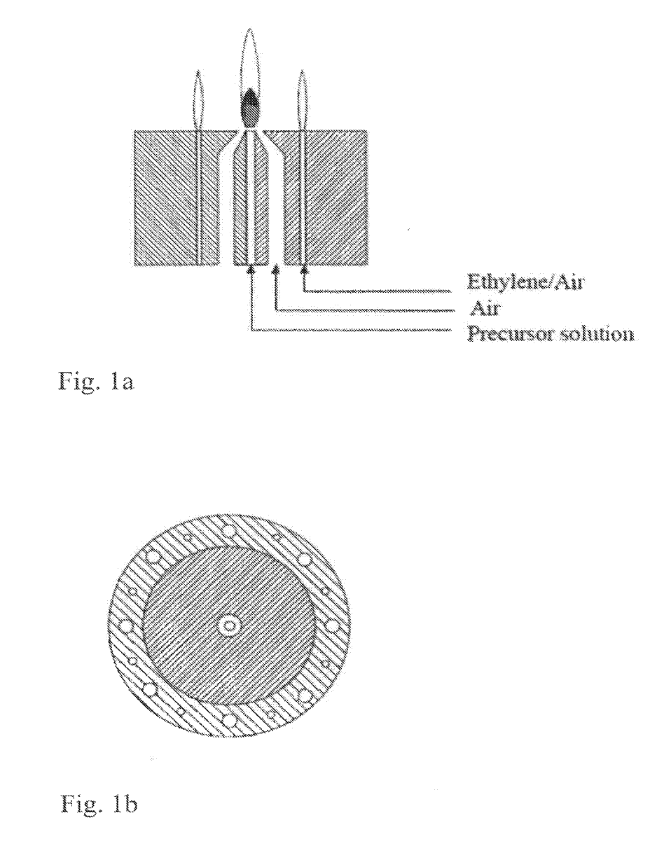

The schematic structure of the two-fluid nozzle is shown in FIGS. 1a (sectional view) and 1b (plan view).

The reference numerals have the following meanings:
1 Two-fluid nozzle
2 Ethylene/air inlet for support flame
3 Air inlet
4 Inlet for precursor solutions

The experiments were aimed at the synthesis of cobalt-based hexaaluminates or mixtures having a high content of the hexaaluminate phase. Here, numerous synthesis parameters were varied, specifically

i) the temperature of the high-temperature zone (from 1000 to 1200° C.);
ii) the mass flow of the precursor feed (320 or 400 mL/h);
iii) the molar ratio of the precursor compounds;
iv) the molality (0.2 and 0.5 mol/kg) of the precursor solution;
v) the atomization pressure of the two-phase nozzle (1.5, 2 or 3 bar);
vi) the type of lanthanum precursor (LAA or LEH).

The results show that a relatively high temperature in the reaction zone and the correct molar ratio of the precursors in the precursor solution promote the formation of the hexaaluminate phase. The mass flow, the molality, the atomization pressure of the nozzle (which influences the droplet size) and the type of lanthanum precursor have only a small influence on the formation of the hexaaluminates. However, other product properties such as the crystallite size and the degree of agglomeration are influenced.

The results of the experiments are summarized in table 1.

TABLE 1

| | Burner | | Quench | Nozzle | | Mass | | | | |
|---|---|---|---|---|---|---|---|---|---|---|
| | Air | C₂H₄ | N₂ | air | Temperature | flow | | Molality β | Mass | Yield |
| Example | [m³/h] | [kg/h] | [m³/h] | [bar] | [° C.] | [mL/h] | Reaction mixture | [mol/kg] | [g] | [g] |
| 1 | 1.6 | 0.03 | 50 | 2 | 1100 | 320 | 87.5 g AlsB; 342.6 g LEH; 7.8 g CoAA | 0.5 | 1400 | 20.5 |
| | | | | | | | 562.1 g Xyl | | | |
| 2 | | | 50 | 2 | 1200 | 320 | 88.4 g AlsB; 345.9 g LEH; 6.8 g CoAA | 0.5 | 1000 | 25.3 |
| | | | | | | | 558.9 g Xyl | | | |
| 3 | | | 50 | 2 | 1200 | 400 | 89.1 g AlsB; 27.1 g LAA; 6.8 g CoAA | 0.5 | 1000 | 14.1 |
| | | | | | | | 877.0 g Xyl | | | |
| 4 | | | 50 | 2 | 1000 | 320 | 89.1 g AlsB; 27.1 g LAA; 6.8 g CoAA | 0.5 | 1000 | 13.1 |
| | | | | | | | 877.0 g Xyl | | | |
| 5 | 1.6 | 0.15-0.07 | 50 | 2 | 1200 | 320 | 93.9 g AlsB; 19.4 g LAA; 6.9 g CoAA | 0.5 | 1000 | 26.6 |
| | | | | | | | 879.9 g Xyl | | | |
| 6 | | | 50 | 2 | 1200 | 320 | 94.3 g AlsB; 15.0 g LAA; 6.9 g CoAA | 0.5 | 1000 | 23.3 |
| | | | | | | | 881.5 g Xyl | | | |
| 7 | | | 50 | 2 | 1200 | 400 | 94.3 g AlsB; 15.0 g LAA; 6.9 g CoAA | 0.5 | 1000 | 17.4 |
| | | | | | | | 881.5 g Xyl | | | |
| 8 | | | 50 | 3.5 | 1200 | 400 | 94.3 g AlsB; 15.0 g LAA; 6.9 g CoAA | 0.5 | 1000 | 25.4 |
| | | | | | | | 881.5 g Xyl | | | |
| 9 | | | min. | 2 | 1200 | 400 | 94.3 g AlsB; 15.0 g LAA; 6.9 g CoAA | 0.5 | 1000 | 20 |
| | | | | | | | 881.5 g Xyl | | | |
| 10 | | | 50 | 2 | 1200 | 400 | 50.3 g AlsB; 7.9 g LAA; 4.7 g CoAA | 0.25 | 1000 | 5.8 |
| | | | | | | | 937.0 g Xyl | | | |
| 11 | | | 50 | 1.5 | 1200 | 400 | 94.3 g AlsB; 15.0 g LAA; 8.8 g CoAA | 0.5 | 1000 | 26.5 |
| | | | | | | | 881.5 g Xyl | | | |
| 12 | | | 50 | 2 | 1100 | 320 | 88.2 g AlsB; 26.8 g LAA; 7.9 g CoAA | 0.5 | 1000 | 11 |
| | | | | | | | 877.1 g Xyl | | | |

In examples 1 to 5, the following constituents were identified qualitatively by means of XRD:

Main constituents: LaAlO₃ and CoLaAl₁₁O₁₉,

Secondary constituents: cubic Al₂O₃ phase (no α-Al₂O₃)

Amorphous phase detectable

In the products from examples 6 to 10, the following constituents were identified qualitatively by means of XRD:

Main constituents: CoLaAl₁₁O₁₉ and cubic Al₂O₃ phase (no α-Al₂O₃)

Secondary constituent: LaAlO₃

Amorphous phase detectable

The crystallite size of the primary particles of the hexaaluminate phase is influenced mainly by the atomization pressure of the two-phase nozzle, the mass flow of the quench and the concentration of the precursor solution used. This crystallite size can be estimated from the XRD pattern and is a few 10 nm (from 10 to 20 nm). The BET surface area is from 60 to 80 m²/g and is in agreement with the particle size determined by means of XRD.

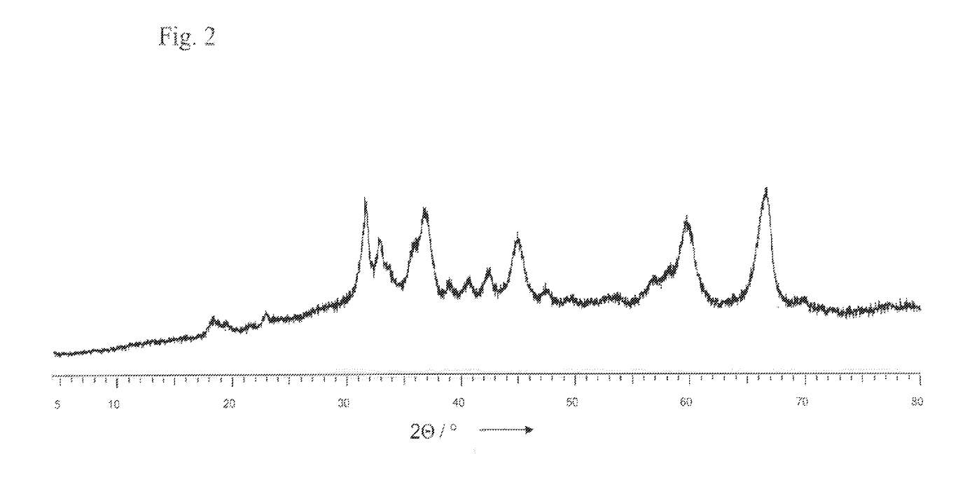

A representative X-ray diffraction pattern is shown in FIG. 2.

In order to determine the catalytic properties, the material was pressed by means of a punch press to give pellets and the pellets were subsequently broken up and pushed through a sieve having a mesh opening of 1 mm. The pellets have a diameter of 5 mm and a height of 5 mm. The target fraction has a particle size of from 500 to 1000 μm.

Preparation of a Comparative Catalyst

The comparative catalyst was prepared as described in WO2013/118078. Cobalt nitrate (83.1 g of Co(NO₃)₃x6H₂O) and lanthanum nitrate (284.9 g of La(NO₃)₃x6H₂O) are dissolved completely in 250 ml of distilled water. The metal salt solution is admixed with 250 g of boehmite, forming a suspension (ratio of Co:La:Al=6:14:80). Disperal from SASOL is used as boehmite.

The suspension is stirred for 15 minutes by means of a mechanically driven stirrer at a stirrer speed of 2000 revolutions per minute. The dissolved nitrates are precipitated completely by adjusting the pH and separated from the solvent by filtration. After drying and washing of the product, the material is subsequently precalcined at 520° C. in a furnace. The calcined material is then pressed by means of a punch press to give pellets and the pellets are subsequently broken up and pushed through a sieve having a mesh opening of 1 mm. The pellets have a diameter of 13 mm and a thickness of 3 mm. The target fraction has a particle size of from 500 to 1000 μm.

For the high-temperature calcination, the material obtained after sieving is heated at 1100° C. for 30 hours in a muffle furnace while passing a stream of 6 liter/minute of air over the material. The furnace is heated to the temperature of 1100° C. at a heating rate of 5° C.

The specific surface area which can be determined by means of the BET method was 8 m²/g.

### Catalysis Experiments

To determine the catalytic properties and the stability of catalysts, these were subjected to a test procedure consisting of six successive phases under process conditions in a laboratory catalysis apparatus. The individual phases of the test procedure differ in terms of the gas composition H₂:CO₂:CH₄ (v/v/v, see Table 2). The reactions were carried out for all phases at 750° C. and 10 bara at a GHSV of 3000 h⁻¹. A minimum amount of 20 ml in each case of sample was used for each test.

TABLE 2

| | Time on | | | |
|---|---|---|---|---|
| | stream/h | H2 | CO2 | CH4 |
| Phase 1 | 50 | 2 | 1 | 0 |
| Phase 2 | 56 | 3 | 1 | 0 |
| Phase 3 | 24 | 2 | 1 | 0.5 |
| Phase 4 | 28 | 2 | 1 | 1 |
| Phase 5 | 28 | 1 | 1 | 0.5 |
| Phase 6 | 33 | 2 | 1 | 0 |

The composition of the product fluids obtained in the reactions was determined by means of GC analysis using an Agilent GC. Evaluation of the results of phases 1, 2 and 6 make it possible to determine the activity of the catalyst for the desired RWGS reaction and for the undesirable secondary reaction of methanation of CO₂ (Sabatier process). Phases 3, 4 and 5 of the test procedure make it possible to draw conclusions regarding the influence of hydrocarbons on the RWGS reaction by methane activation and also regarding the carbonization behavior and the deactivation tendency of the catalyst. Comparison of the results of phases 1 and 6 makes it possible to draw conclusions regarding the long-term and carbonization behavior.

In Table 3, the catalytic properties of the catalyst of the invention (sample 1) and of the comparative catalyst (sample 2) have been compared.

TABLE 3

| | Column (C) | | | | | |
|---|---|---|---|---|---|---|
| | 1 | 2 | 3 | 4 | 5 | 6 |
| | Conversion | Conversion | Conversion | Conversion | Conversion | Conversion |
| | of H2 | of H2 | of H2 | of H2 | of H2 | of H2 |
| | in phase | in phase | in phase | in phase | in phase | in phase |
| | 1/% | 2/% | 3/% | 4/% | 5/% | 6/% |
| Theoretical H2 | 32 | 24 | 31 | 31 | 47 | 31 |
| conversion in | | | | | | |
| equilibrium | | | | | | |
| without CH4 | | | | | | |
| formation | | | | | | |
| Theoretical H2 | 51 | 48 | 28 | 12 | 8 | 51 |
| conversion in | | | | | | |
| equilibrium | | | | | | |
| taking | | | | | | |
| methanation | | | | | | |
| (CH4 | | | | | | |
| formation) into | | | | | | |
| account | | | | | | |
| Sample 1 | 32 | 24 | 31 | 31 | 44 | 31 |
| Sample 2 | 47 | 45 | 34 | 24 | 31 | 45 |

| | Column (C) | | | | | |
|---|---|---|---|---|---|---|
| | | 8 | 9 | | | |
| | | Formation | Formation | | | |
| | | of | of | | | |
| | | CH4/ | CH4/ | 10 | 11 | 12 |
| | 7 | mmol/h | mmol/h | Conversion | Conversion | Conversion |
| | Column | per g of | per g of | of CH4 in | of CH4 in | of CH4 in |
| | 6 − | cat in | cat in | phase | phase | phase |
| | column 1 | phase 1 | phase 6 | 3/% | 4/% | 5/% |
| Theoretical H2 | | | | | | |
| conversion in | | | | | | |
| equilibrium | | | | | | |
| without CH4 | | | | | | |
| formation | | | | | | |
| Theoretical H2 | | | | | | |
| conversion in | | | | | | |
| equilibrium | | | | | | |
| taking | | | | | | |
| methanation | | | | | | |
| (CH4 | | | | | | |
| formation) into | | | | | | |
| account | | | | | | |
| Sample 1 | −1% | 2 | 0.5 | −4 | −2 | −1 |
| Sample 2 | −2% | 57 | 42 | −8 | 5 | 12 |

Sample 1 = hexaaluminate produced according to the invention (flame CoLaAl₁₁O₁₉) as per Example 6
Sample 2 = Comparative catalyst (wet-chemically prepared CoLaAl₁₁O₁₉)

The results of the catalysis experiments show the following:

Column 7: Sample 1 (according to the invention) tends to display a lower carbonization tendency and thus a lower deactivation tendency than Sample 2 (comparison). Both samples display relatively good stability against deactivation.

Columns 8 and 9: Sample 1 (according to the invention) displays little/barely any methanation. Sample 2 (comparison) displays very distinct methanation.

Columns 3, 4 and 5: Sample 1 (according to the invention) displays, particularly in the presence of methane, higher or equally high H₂ conversions for the reverse water gas shift reaction compared to Sample 2 (comparison). According to columns 8 and 9, Sample 2 (comparison) catalyzes methane formation to a significantly greater extent, which has to be taken into account when comparing the H₂ conversions as per columns 1, 2 and 6. Owing to the formation of methane, overall higher H₂ conversions are obtained for Sample 2 (comparison). For comparison, the theoretical H₂ conversions with and without methane formation in thermodynamic equilibrium were calculated (rows 1 and 2, Table 3). As can clearly be seen, Sample 1 according to the invention displays no methanation activity.

Columns 10, 11 and 12: Sample 1 (according to the invention) does not convert methane present in the gas phase in the presence of CO₂ and H₂. The reference catalyst (Sample 2) activates methane and converts it, particularly at relatively high concentrations (see columns 11 and 12), which is disadvantageous for the desired reaction. This is also reflected in the lower H₂ conversions for Sample 2 (comparison) as per columns 4 and 5. Negative conversions (methane formation) results from a slight methanation activity of the samples.

1. A process for preparing aluminates of formula (I):
A₁BₓAl₁₂₋ₓO_{19-y}
wherein
A is at least one element from the group consisting of Sr, Ba and La,
B is at least one element from the group consisting of Mn, Fe, Co, Ni, Rh, Cu and Zn,
x=0.05-1.0,
y is a value determined by the oxidation states of the other elements, the process comprising:
(i) providing one or more solutions or suspensions comprising precursor compounds of the elements A and B and also a precursor compound of aluminum in a solvent;
(ii) converting the solutions or suspensions into an aerosol;
(iii) introducing the aerosol into a directly or indirectly heated pyrolysis zone;
(iv) carrying out pyrolysis; and
(v) separating resulting particles comprising aluminate of formula (I) from the pyrolysis gas.

2. The process according to claim 1, wherein the element A is La and the element B is Co or Ni.

3. The process according to claim 1, wherein the element A is Sr or Ba and the element B is Ni.

4. The process according to claim 1, wherein the precursor compound of the element A or B is an acetylacetonate.

5. The process according to claim 1, wherein the precursor compound of the element A or B is a carboxylate.

6. The process according to claim 5, wherein the carboxylate is 2-ethylhexanoate.

7. The process according to claim 1, wherein the precursor compound of the element A or B is an alkoxide.

8. The process according to claim 1, wherein the precursor compound of the element A or B is a nitrate.

9. The process according to claim 1, wherein the precursor compound of the element A or B is an oxide or hydroxide.

10. The process according to claim 1, wherein the precursor compound of aluminum is an alkoxide.

11. The process according to claim 7, wherein the precursor compound of aluminum is aluminum sec-butoxide.

12. The process according to claim 1, wherein the solvent is xylene.

13. The process according to claim 1, wherein the pyrolysis is carried out at a temperature of from 900 to 1500° C.

14. The process according to claim 1, wherein the pyrolysis zone is heated by a flame.

15-20. (canceled)
